(19) United States
(12) Patent Application Publication
(10) Pub. No.: US 2018/0061175 A1
(43) Pub. Date: Mar. 1, 2018

(54) MULTI-REEL GAME DEVICE ENABLING USER TO CONTROL BETTING AMOUNT

(71) Applicant: NEXCADE CO.,LTD., Seoul (KR)

(72) Inventor: Yong Hwan KIM, Gyeonggi-do (KR)

(21) Appl. No.: 15/363,400

(22) Filed: Nov. 29, 2016

(30) Foreign Application Priority Data
Aug. 25, 2016 (KR) 10-2016-0108480

(51) Int. Cl. G07F 17/32; G07F 17/34

(52) U.S. Cl. CPC G07F 17/3213; G07F 17/34; G07F 17/3244

(57) ABSTRACT

A multi-reel game device enables a user to control a betting amount. The multi-reel game device includes at least two reel games respectively including reel display windows and displayed on a single screen, each of the reel display windows displaying at least one reel symbol in three or more rows and three or more columns, and a controller simultaneously spinning reels of the reel display windows when the betting amount is m selected through input buttons, stopping the reels after a predetermined time, and allotting a winning score according to a dividend rate when more than a predetermined number of identical symbols of the stopped reels of the reel display window are determined to be included in a predetermined winning line. Thus, the present invention has an effect to enhance interest in and enjoyment of a game because a player can play multiple reel games simultaneously.

### CROSS REFERENCE TO RELATED APPLICATION

The present application claims priority to Korean Patent Application No. 10-2016-0108480, filed Aug. 25, 2016, the entire contents of which is incorporated herein for all purposes by this reference.

### BACKGROUND

### 1. Field of the Invention

The present invention generally relates to a reel game device. More particularly, the present invention relates to a multi-reel game device enabling a user to control a betting amount configured with a plurality of games displayed on a single screen, thus a gamer is capable of playing multiple reel games at the same time.

### 2. Description of the Related Art

A reel game device is divided into a mechanical reel game device and an electronic reel game device. The mechanical reel game device spins or stops a cylindrical reel, on which multiple symbols are arranged in a line, using a drive motor, and shows the cylindrical reel symbols on a screen when the reel is stopped. In case of the electronic reel game device, multiple symbols are randomly displayed on a display screen such as a monitor, and the like.

This type of existing game device is disclosed in Korean Patent Application Publication No. 10-2007-0043190, entitled Method of controlling game machine.

Referring to FIGS. 1 and 2, a reel game device is configured to include: a money insertion detection unit 11 for detecting insertion of commodity money such as coins or bills, or insertion of token money such as tokens or scrip money; a central processing unit 12 for automatically controlling the operation of the game device by receiving a money insertion signal from the money insertion detection unit 11; an input unit 13 for controlling the operation of the central processing unit 12; a display 14 controlled by the central processing unit 12 for displaying reels; and a gift dispenser 15 controlled by the central processing unit 12 for dispensing a gift.

The input unit 13, as shown in FIG. 2, is configured to include a betting switch for inputting a betting number, a start switch for inputting a game start signal, and a gift dispensation switch 11a a for inputting a gift dispensation signal. Well-known components such as cathode-ray tube monitors, PDPs, and LCDs, in which game images and text including scores can be displayed on a screen, are used for the display 14.

A lamp lighting unit 16 is configured to be lit or to blink according to the game progress status, in order to visually express the progress of the game.

The central processing unit 12 receives an output signal from the money insertion detection unit 11 and the input unit 13, performs a reel game, and automatically controls the operations of the display 14 and the gift dispenser 15.

This kind of the existing reel game device only allows for the playing of one game at a time. Therefore, there is no means that the player is capable of playing multiple games simultaneously.

To partially solve the above problems, multiple game devices are arranged by being interconnected, but in this case, different reel display windows are separately operated and displayed, thus the results of each game may be different. Accordingly, players may not be satisfied with the results.

Additionally, an operator who manages reel game devices obtains a profit depending on the number of users by effectively managing the devices. However, users playing the reel game devices tend to play games at particular times.

Accordingly, it is difficult for an operator to accommodate players who wish to use the reel game devices if all the reel game devices are fully occupied. Further, spatial constraints of the game room and investment costs also exist.

Consequently, a single reel game device on which multiple reel games can be played simultaneously is required.

### SUMMARY

To solve the above problem, an aspect of the present invention is to provide a multi-reel game device enabling a user to control a betting amount, whereby a player can play multiple reel games simultaneously.

Another aspect of the present invention is to provide a multi-reel game device enabling a user to control a betting amount, whereby a player can play multiple games at the same time since the multi-reel game device can display at least two reel display games on a single screen.

A further aspect of the present invention is to provide a multi-reel game enabling a user to control a betting amount, whereby the device can simultaneously operates multiple reel games and allots a winning score according reels displayed in each reel game.

Yet another aspect of the present invention is to provide a multi-reel game device enabling a user to control a betting amount, whereby the device simultaneously spins reels of a game that is selected by a player as well as reels of games that are not selected by the player among multiple reel games displayed on a screen.

Still another aspect of the present invention is to provide a multi-reel game device enabling a user to control a betting amount, whereby the device plays a bonus game or a jackpot game, or displays a jackpot score when a reel symbol displayed as a result of a game corresponds to a predetermined condition.

According to one aspect of an embodiment of the present invention, there is provided a multi-reel game device enabling a user to control a betting amount, whereby at least one winning line that includes symbols, each of symbols being included on each reel to be displayed in a reel display window, is set in the multi-reel game device, the multi-reel game device including: at least two reel games respectively including reel display windows and displayed on a single screen, each of the reel display windows displaying at least one reel symbol in three or more rows and three or more columns and including at least two betting buttons displaying different betting amounts such that a player is capable of selecting a betting amount for each reel display window; and a controller simultaneously spinning the reels of the reel display window for which the betting amount is selected by selecting one of the betting buttons, simultaneously stopping the reels of the reel display window after a predetermined time, and allotting a winning score according to a dividend rate when more than a predetermined number of identical symbols on the stopped reels displayed the reel display window are determined to be included in a predetermined winning line.

In addition, the controller may differently display the reel display window with the betting amount being selected and the reel display window without the betting amount being selected.

In addition, the controller may display a betting button displaying “0” as the same as the selected betting button when the betting button displaying “0” is selected. The betting buttons includes at least two buttons displaying different betting amounts, the betting amount of the reel display window is determined by selecting one of the betting buttons, and the determined betting amount is canceled when the selected betting button has been selected once again or another betting button is selected.

Accordingly, a multi-reel game device enabling a user to control a betting amount according to one embodiment of the present invention has an effect to enhance interest in and enjoyment of a game because a player can play multiple reel games simultaneously.

Also, in a multi-reel game device enabling a user to control a betting according to one embodiment of the present invention, a player can play multiple reel games in a small room. Therefore, a game room can be more effectively managed.

In addition, as the present invention displays multiple reel games on a single screen and a winning result of a reel game that is not selected by a player is also displayed, and thus the player may feel that the game is fairly played.

Also, as the present invention additionally provides a bonus game and a jackpot game, a player can enjoy various games by playing the bonus game and the jackpot game.

### BRIEF DESCRIPTION OF THE DRAWINGS

The above and other aspects, features and other advantages of the present invention will be more clearly understood from the following detailed description when taken in conjunction with the accompanying drawings, in which:

FIG. 1 is a block diagram of a conventional single-reel game device;

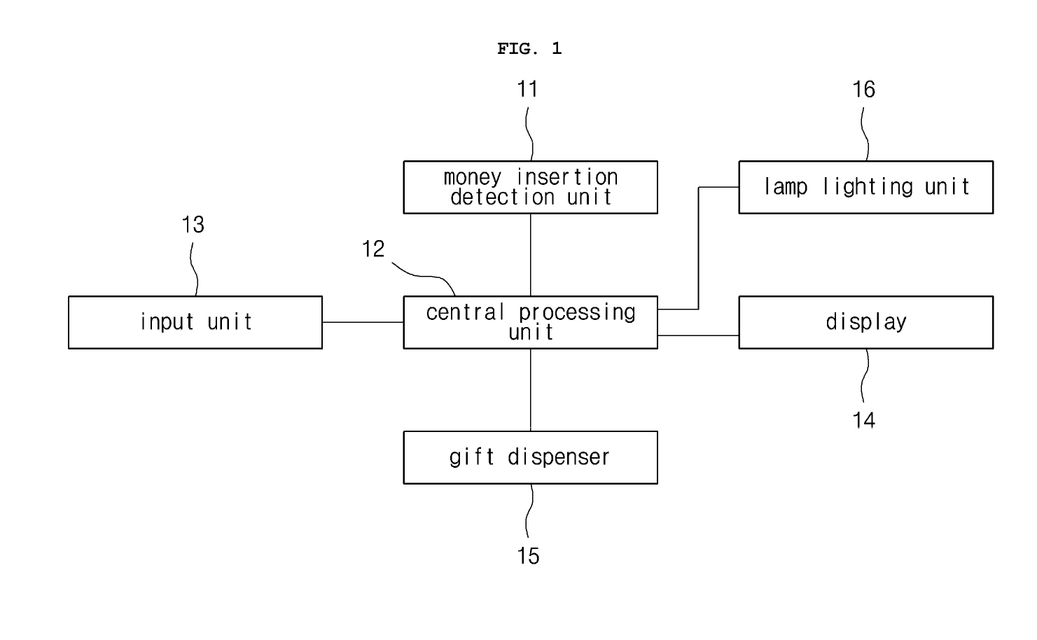

FIG. 2 is a perspective view of a conventional reel game device;

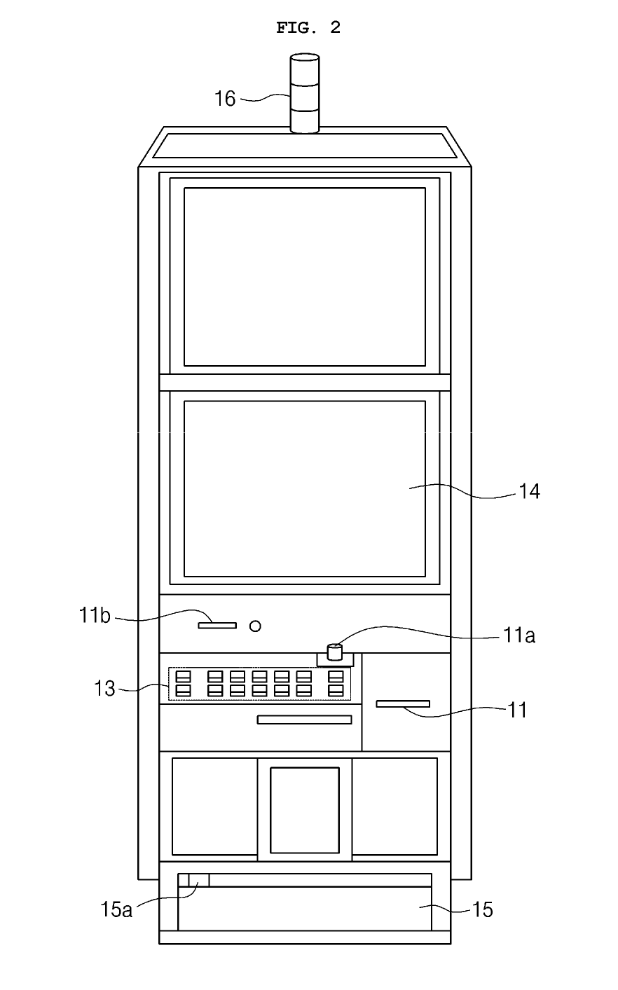

FIG. 3 is a main configuration diagram of a multi-reel game device according to an embodiment of the present invention;

FIG. 4 is a view showing an example of a screen configuration diagram according to the embodiment of the present invention;

FIG. 5 is a view showing examples of winning lines of a reel display window of the present invention;

FIG. 6 is a view showing an example of input buttons;

FIG. 7 is a view showing an example of a comparison screen of a reel display window for which a betting amount is selected and a reel display window for which a betting amount is not selected;

FIG. 8 is a view showing an example in which symbols of the reel display window after spinning are included in a winning line of LINE 7; and

FIG. 9 is a flowchart explaining a method of controlling a multi-reel game device according to an embodiment of the present invention.

### DETAILED DESCRIPTION

All terms or words used herein should not be interpreted as being limited merely to common and dictionary meanings but should be interpreted as having meanings and concepts which are defined within the technical scope of the present invention.

Unless the context clearly indicates otherwise, it will be further understood that the terms “comprises”, “comprising,”, “includes”, and/or “including”, when used herein, specify the presence of stated features, integers, steps, operations, elements, and/or components, but do not preclude the presence or addition of one or more other features, integers, steps, operations, elements, components, and/or groups thereof. Also, the terms “˜ part”, “˜ unit”, “module”, “apparatus” and the like mean a unit for processing at least one function or operation and may be implemented by a combination of hardware and/or software.

One embodiment of the present invention will be hereinafter described with reference to the accompanying drawings.

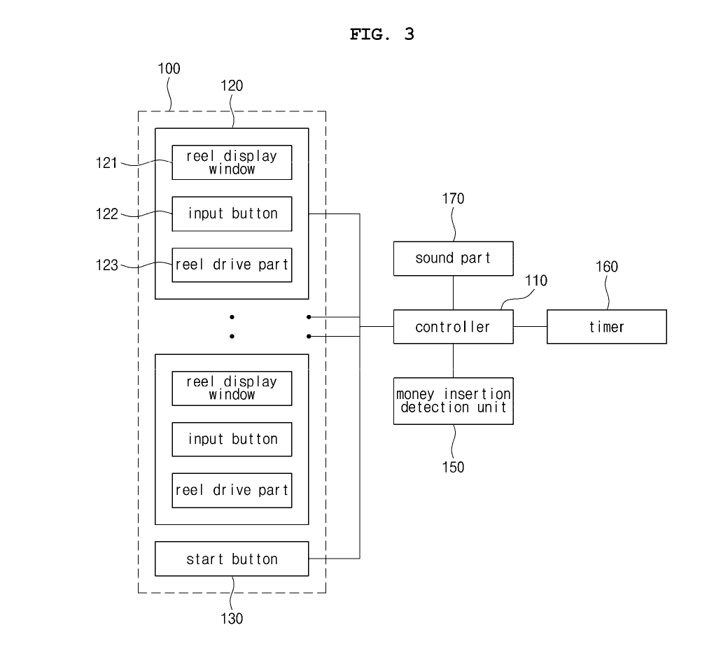

FIG. 3 is a main configuration diagram of a multi-reel game device according to an embodiment of the present invention. As shown in FIG. 3, the multi-reel game device of the present invention is configured on a single screen including at least two individual reel games 120 and a controller 110 controlling the at least two reel games 120.

It is one feature of the present invention that at least two individual reel games 120 and a controller 110 capable of simultaneously controlling the at least two reel games 120 such that a single player can play multiple reel games simultaneously is provided.

To implement the above description, the individual reel games 120 have reel display windows 121, wherein each of the reel display windows 121 includes reels formed by reel characters displaying at least one symbol in three or more rows and three or more columns. The controller 110 sets at least one winning line, wherein the winning line includes symbols, each of symbols is included in each reel to be displayed in a reel display windows 121, simultaneously spins the reels of the reel display windows 121 when a players have completed the betting and stops them, and allots winning scores according to a dividend rate.

In more detail, the individual reel game 120 includes: a reel display window 121 for displaying at least one symbol on each reel in three or more rows and three or more columns; in input buttons 122; a reel drive part 123 for driving the reel; and a winning score display part for displaying a winning score as the result of driving the reel.

The reel display window 121 may be configured with 3×1 reels, 4×1 reels, 3×3 reels, 5×3 reels, 6×3 reels, and the like, but in the present invention, the case in which a reel display window having 3 rows and 5 columns is used.

Symbols of the reel and an operation method of the reel display windows 121 are widely known to people skilled in the relevant field, so the detailed descriptions thereof are omitted.

At least two reel games 120 including reel display windows 121 are configured to be displayed on a single screen 100.

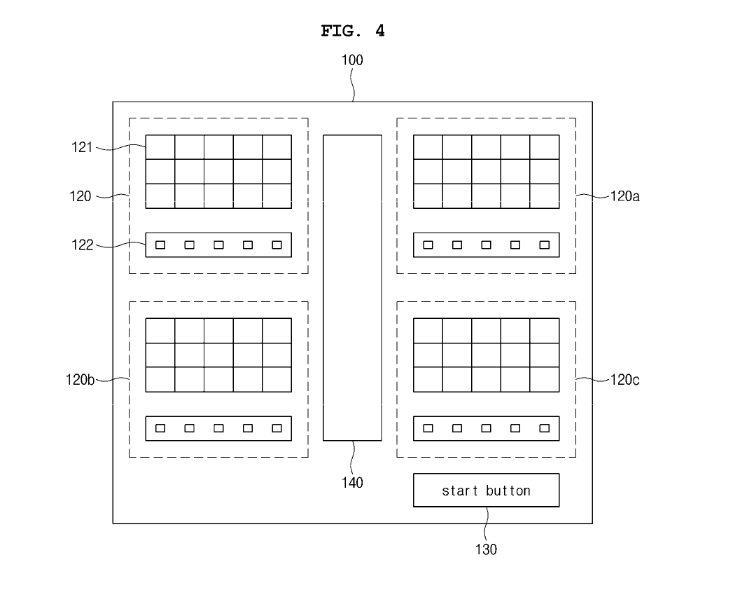

Referring to FIG. 4 showing an example of a screen configuration diagram according to the embodiment of the present invention, four reel games 120 including reel display windows 121 are displayed on the single screen 100, the reel display windows 121 are respectively provided with input buttons 122 on one side of the reel display window 121. In FIG. 4, the input buttons 122 are located in a lower part of the reel display window 121.

In addition, the reel display window 121 may display images or text that is necessary for a game. In the embodiment of the present invention, 15 reel symbols (characters) are configured in an array of 3 rows and 5 columns (3*5) and the reels are variably displayed by an operation of the reel drive part 123.

The input buttons 122 include betting buttons displaying different betting amounts such that a player is capable of selecting the betting amount.

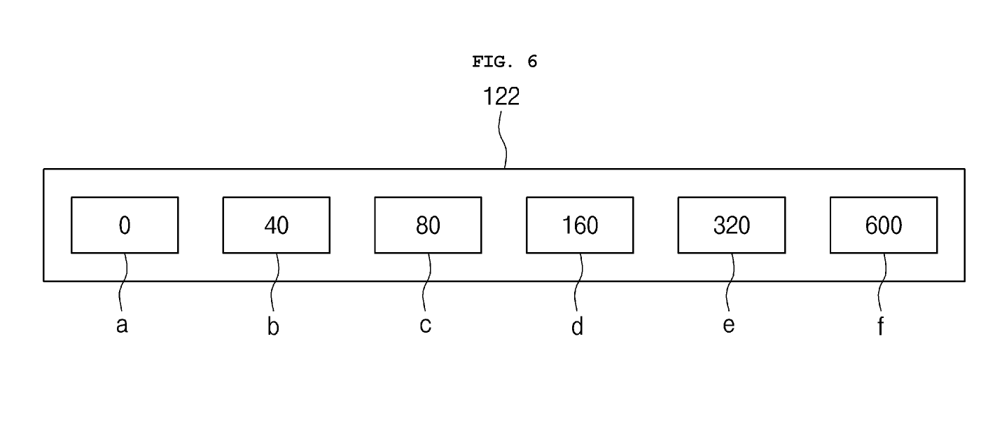

Referring to FIG. 6 showing an example of the input button, the input button is configured with betting buttons displaying different betting amounts.

In one embodiment, the betting buttons may be provided with differing betting amounts of “0”, “40”, “80”, “160”, “320”, and “600”.

In addition, a selected betting button and non-selected betting buttons are differently displayed.

In other words, the betting buttons, except for the selected betting button, are displayed as non-selected buttons.

The betting button is turned on or turned off by turning on or off a lamp when the betting button is selected.

The input buttons 122 are provided in a lower part of each reel display window 121 such that the player is capable of easily selecting a betting amount for each reel display window 121.

In addition, the input buttons 122 include deactivation buttons. When the deactivation button is selected, the controller 110 determines that the corresponding reel display window 121 as a reel display window 121 without a betting amount.

In the above case, all betting buttons of the corresponding reel display window 121, except for the deactivation button, are turned off such that the player is aware that the betting amount is not selected.

When the player has input a betting amount in a previous or in a current game and does not want to bet any more, the player may select the deactivation button to make the betting amount of the corresponding reel display window 121 be “0”. Thus, the corresponding reel display window 121 is handled not to be bet.

Referring to FIG. 6, a betting button displaying “0” is used as deactivation button, when the betting button displaying “0” is input, the betting button displaying “0” is turned on or off as the same as the selected betting button described above by turning a lamp on or off.

In other words, when the betting button displaying “0” is input, the corresponding betting button is activated the same as the betting button in which a betting amount is determined. The controller 110 differently displays the reel display window 121 in which the betting button displaying “0” is selected and symbols of the reel display window 121 in which the betting button is not selected or is selected are displayed differently by varying contrast or color thereof until a start button of the multi-reel game device is input.

The betting button displaying “0” is activated such that the player is clear that the betting amount of the corresponding reel display window 121 is “0”.

In addition, the betting amount of the reel display window 121 determined by selecting one of the betting buttons, and the determined betting amount is canceled when the selected betting button has been selected once again or another betting button is selected.

In other words, when the betting amount is selected in a previous game or in a current game, the selected betting amount is canceled by inputting the selected betting button once again.

Alternatively, when the betting amount is selected, the selected betting amount is canceled by inputting another betting button.

For example, when the betting button displaying “40” is selected, the betting amount is set to “40”; however, the set betting amount “40” is canceled by selecting the betting button displaying “40” once again. Alternatively, when the betting button displaying “80” is selected after selecting the betting button displaying “40”, the set betting amount “40” is canceled and is replaced to “80”.

Particularly, when the betting button displaying a corresponding betting amount is input, the selected betting button may be turned on to display that the corresponding betting amount is set, and the corresponding betting amount may be canceled by inputting the selected betting button once again.

Herein, all betting buttons of the input buttons 122 may be operated as the deactivation button.

In addition, the input buttons 122 of each reel display window 121 is configured with at least two betting buttons displaying different betting amounts from each other, and determines as the betting amount the amount of the betting button that is finally selected before the start button is input.

In other words, when the betting amount is set and the corresponding betting button is turned on in a current game and the player inputs another betting button, the new input betting button is turned on and the previous selected betting button is turned off, and the betting amount of the new betting button that is finally input is set as the betting amount.

Herein, finally means the last selected betting button before inputting a start button when the start button is provided.

In addition, the controller 110 operates to simultaneously spin and stop the reels of each reel display window 121 with the betting amount being selected when the start button is input.

A money insertion detection unit 150 uses a well-known sensor for detecting insertion of coins or tokens through a coin slot, or a well-known note sensing device for detecting insertion of bills or scrip money through a paper money slot or a card reader.

A timer 160 displays a remaining betting time or a progress of the remaining betting time as a graph.

A sound part 170 is controlled to output some rhythmical music with the progress of the game. Also, the sound part 170 makes sound effect when a jackpot score is displayed or when a jackpot game or bonus game is played.

Additionally, to add visual effect, a lamp outputting various colors of light may be installed and operated.

When the betting amount is selected through the input buttons 122, the controller 110 simultaneously spins the reels of the reel display window 121 with the betting amount being selected and the reel display window 121 without the betting amount being selected, simultaneously stops after a predetermined time, and allots by adding up a winning score according to a dividend rate when more than a predetermined number of identical symbols of the stopped reels of the reel display window 121 with the betting amount being selected are determined to be included in a predetermined winning line.

In addition, when the betting amount is selected through the input buttons 122, the controller 110 may sequentially spin the reels of the reel display window 121 with the betting amount being selected and the reel display window 121 without the betting amount being selected, and sequentially stop the reels after a predetermined time.

For example, the controller 110 may sequentially spin the reels of the reel display windows 121 in a descending order of betting amount, in an ascending order of betting amount, or in a random order and sequentially stop in a span order.

In addition, the controller 110 may display the reel display window 121 without the betting amount being selected in a stooped state until the reel display window 121 with the betting amount being selected stops spinning.

Herein, the reel display window 121 without the betting amount being selected may be differently displayed than the reel display window 121 with the betting amount being selected by displaying the window in monochrome or in different color.

A winning line may be variably set. However, in the embodiment of the present invention, an example in which a reel display window 121 is formed as an array of 3×5 and 25 winning lines are predetermined and stored in a system is described. In this case, each of the winning lines includes 5 symbols, each of the 5 symbols is selected from each column of the array. The winning lines are properly set according to a client's request at the time of shipment.

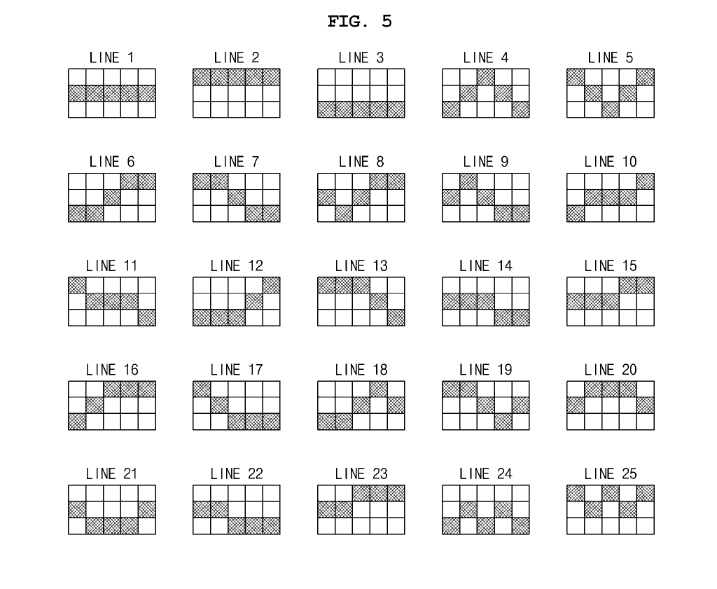

Referring to FIG. 5 showing an example of winning lines of a reel display window of the present invention, specific lines from LINE 1 to LINE 25 are determined, and a player may select a winning line among them to bet on.

In addition, the selected winning line is displayed in one side of the screen 100 such that the player may easily check the selected winning line.

Additionally, the input units 122 may further include an automatic button. Accordingly, the player does not input the start button for every game but the game may be started automatically when a start condition is satisfied.

These functions may be added as a matter of convenience, therefore the detailed description is omitted.

By control of the controller 110, the reel drive part 123 spins the reels of the reel display window 121 at the same time and simultaneously stops them after a predetermined time has passed.

As a result of driving the reel drive parts 123, the reels of the reel display windows 121 stop and display certain symbols. At this time, if more than a predetermined number of the same symbols are included in the winning line that has been selected by the player, the controller 110 displays a winning score according to a dividend rate on a winning score display part.

In the present invention, when three or more of the same symbols of the stopped reels are included in the winning line selected by the player, it is determined a win.

When the controller 110 determines that the player has completed the betting through the input buttons 122, the controller 110 simultaneously spins the reels of the reel display windows 121 and simultaneously stops the reels after a predetermined time has passed by controlling the reel drive parts 123, allots a winning score according to a dividend rate when more than a predetermined number of identical symbols of the stopped reels of the reel display window 121 are determined to be included in a winning line, and displays the winning score on the winning score display part.

The controller 110 determines that the betting has been completed when all the betting amounts are selected through the betting buttons (a˜f) of the input buttons 122 for the individual reel game 120, when the start button 130 is input, or when the betting time that is displayed on the individual timer 160 or on the timer 130 has finished. Then, the controller 110 spins the reels of the reel display windows 121 by simultaneously controlling the reel drive part 123 of each reel display window 121.

The bonus display part is configured to displays a jackpot score when the game result of an individual reel game 120 corresponds to the jackpot score.

Also, when the result of a game is set to lead to a jackpot game, the jackpot game is played by the jackpot game part (not shown).

As the display of the jackpot score, or the play and display of the jackpot game is common, the detailed description is omitted.

The controller 110 receives an output signal from the money insertion detection unit 150 and the input buttons 122, and controls the operations of the timer 160, the reel drive part 123, the winning score display part, the sound part 170, and the bonus display part while performing a reel game.

In other words, when the controller 110 determines that the player has completed the betting through the input buttons 122, the controller 110 simultaneously spins the reels of the reel display windows 121, simultaneously stops the reels after the predetermined time, allots the winning score according to the dividend rate when more than a predetermined number of identical symbols of the stopped reels of the reel display windows 121 are determined to be included in the selected winning line, and displays the winning score on the winning score display part.

The controller 110 determines that the betting has been completed when all the betting amounts are selected through the betting buttons (a˜f) of the input buttons 122 for the individual reel game 120, when the start button 130 is input, or when the betting time that is displayed on the timer 160 has finished. When betting has been completed, the controller 110 simultaneously drives the reel drive parts 123 for the individual reel game 120 to spin the reels of the reel display windows 121.

Herein, the controller 110 differently displays and spins the reel display window 121 with the betting amount being selected with the reel display window 121 without the betting amount being selected.

In addition, the start button 130 may be provided on one side of the screen 100 as shown in FIG. 4. When the start button 130 is placed on the screen, a player may have a slight impact on his or her finger, thus the impact may lead to a pain when garners, who on average play 3 hours and enjoy 500 reel games per hour play the game. Therefore, it is preferable to provide the start button 130 on one side of the multi-reel game device, not on the screen 100.

In addition, the reel display window 121 with the betting amount being selected and the reel display window 121 without the betting amount being selected are differently displayed such that the player may easily recognize it.

In other words, the reel display window 121 without the betting amount being selected may be displayed in monochrome, or may be displayed having different color compared with the reel display window 121 with the betting amount being selected.

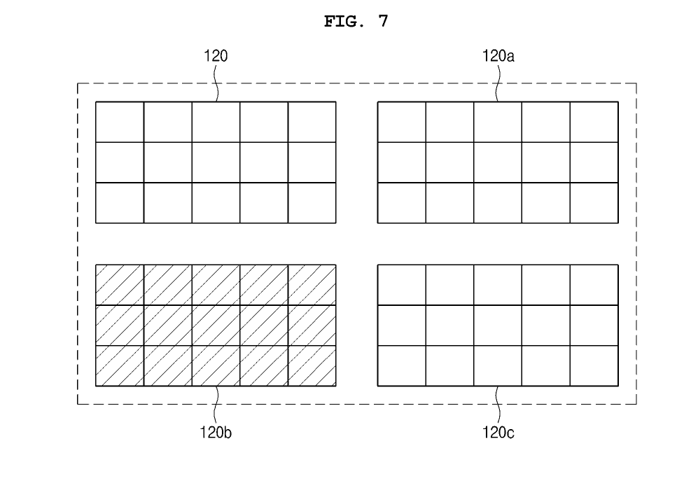

In one embodiment, referring to FIG. 7 showing an example of a comparison screen of a reel display window with a betting amount being selected and a reel display window without a betting amount being selected, the reel display window without the betting amount being selected is displayed in monochrome.

In FIG. 7, monochrome symbols are expressed by diagonal lines.

In addition, when more than a predetermined number of identical symbols of the stopped reels of the reel display window 121 without the betting amount being selected are determined to be included in a predetermined winning line, the controller 110 turns on the corresponding winning line or the symbols of the reels such that the player may recognize it.

Then, the controller 110 simultaneously stops spinning of the reels after a predetermined time, and determines whether a winning score is obtained for the player.

In other words, when three or more of the same symbols of the stopped reels are included in the predetermined winning line, a winning score according to a dividend rate is respectively displayed on the winning score display part.

Also, when the stopped reels of the reel display window 121 are the same as a predetermined symbols that are set to lead to a bonus game or a jackpot, and when the winning line selected by the player includes three or more of the same symbols, the controller 110 may play a bonus game and allot a bonus score, display a jackpot score and allot the jackpot score, or play a jackpot game.

An administrator or the player may select one among the play of the bonus game, the allotment of the jackpot score, or the play of the jackpot game.

The bonus display part displays the play of the bonus game and the bonus score on the screen 100. The jackpot score and the play of the jackpot game may be displayed on the individual reel display windows 121, but may be also displayed in bonus display part.

Herein, when the jackpot game is played, the controller 110 makes sound effect through the sound part 170 in order to notify the player of the winning or the start of the jackpot game.

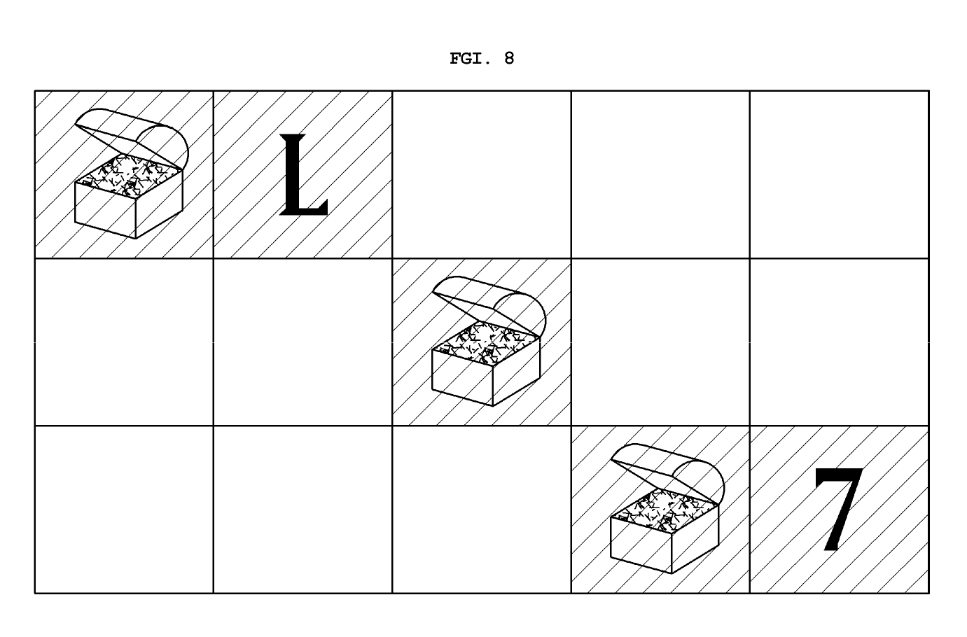

For example, in FIG. 8, referring to a view showing an example in which a player selects LINE 7 among the 25 winning lines and wins, the 3 jewel box symbols are included in the line.

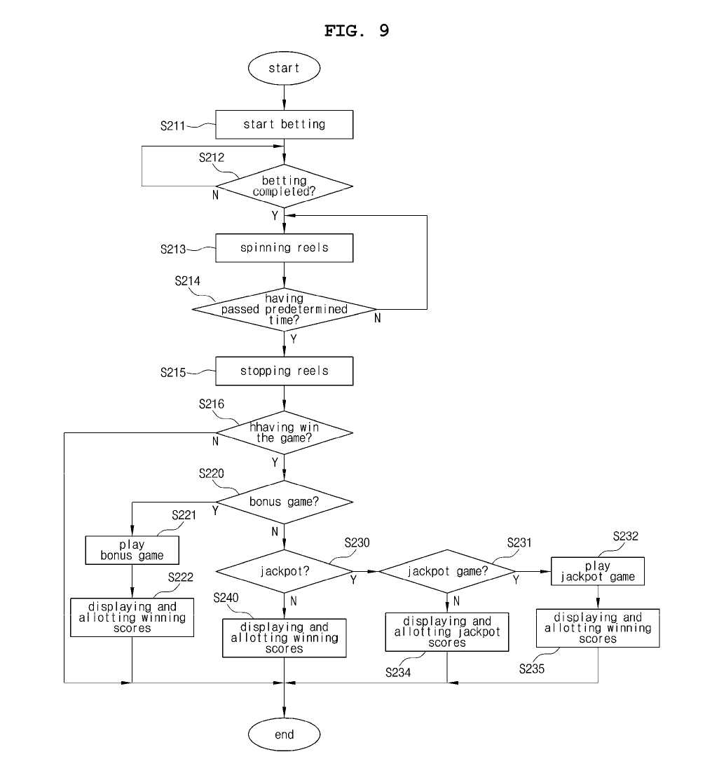

FIG. 9 is a flowchart explaining a method of controlling a multi-reel game device according to an embodiment of the present invention. As shown in the figure, the control method of the multi-reel game device includes at least two reel games respectively including reel display windows and displayed on a single screen, each of the reel display windows displaying at least one reel symbol in three or more rows and three or more columns is as follows. When a betting amount for each reel game 120 is selected through the input buttons 122 (S211); the controller 110 determines whether the betting has been completed (S212), spins the reels of the reel display windows 121 at the same time (S213) when the controller 110 determines that the betting has been completed at step S212, and stops the reels of the reel display windows 121 after a predetermined time (S214 to S215).

In the steps S214 and S215, the reel display window 121 with the betting amount being selected and the reel display window 121 without the betting amount being selected may be simultaneously spun and stopped, or the reel display window 121 with the betting amount being selected may be sequentially spun and stopped, or the reel display window 121 without the betting amount being selected may be displayed in a stopped state until the reel display window 121 with the betting amount being selected stops spinning.

After the reels stop at step S215, the controller 110 determines whether more than a predetermined number (3 in the present embodiment) of identical symbols of the stopped reels of are included in a predetermined winning line, then the controller 110 allots a winning score for each reel display window 121 according to a dividend rate (S220 to S243).

In more detail, at step S210, the controller 110 may display a betting time when the controller 110 determines that credit is inserted through the money insertion detection unit 110.

Herein, the controller 110 displays the remaining betting time or the progress of the remaining betting time as a graph in the timer 160 such that the player visually checks the betting progress status.

Also, at step S211, the player bets by selecting the betting amount.

The betting amount is selected by using the betting buttons (a˜f). Accordingly, when the betting button is selected, the corresponding displayed credit of the betting button is selected.

At step S212, the controller 110 determines whether the betting has been completed for each reel game 120, through the input buttons 122. The controller 110 determines that the betting is completed when betting amounts of all reel games 120 are selected through the betting buttons (a˜f) of the input button 122, as described above, when the start button 130 is selected, or when the betting time displayed in the timer 160 has finished.

At step S213, when the controller 110 determines that the betting has been completed at step S212, the controller 110 simultaneously outputs control signals for driving the reel drive parts 123 of the individual reel games 120, so as to spin the reels of the reel display windows 121.

When the reels of the individual reel games 120 spin at step S213, the controller 110 determines whether a predetermined time has passed (S214). When the predetermined time has passed, the controller 110 transmits control signals for simultaneously stopping the reels of the individual reel games 120 to the reel drive parts 123 of the individual reel games 120 (S215) in order that the stopped reels have the same symbols.

Herein, the game result may be displayed in each reel display windows 121.

At step S215, after the reels of the individual reel games 120 stop, then, depending on the winning result, the controller 110 controls a system to play a bonus game (S221 to S222), to allot a winning score (S240), when the jackpot is won, to display and allot a jackpot score (S234), or to play a jackpot game (S232 to S233).

The controller 110 determines whether the winning line selected by the player includes three or more same symbols.

When the controller 110 determines that the player has not won the game, the controller 110 terminates the game or plays the next game. Alternatively, when the player wins the game, the controller 110 determines whether a bonus game is won (S220).

As described above, when the symbols on the stopped reels of the reel display windows 121 are the same as the symbols that are set to lead to a bonus game, the bonus game is played.

When a condition for the bonus game is satisfied at step S220, the bonus game is played (S221). Then, as the result of the bonus game, a winning score is displayed and allotted.

As the results of the games may be differently displayed for the individual reel games 120, it is preferable to play the bonus game in each reel display windows 121.

On the other hand, when the condition for the bonus game is not satisfied at step S220, a jackpot condition is checked (S230).

When symbols on the stopped reels of the reel display windows 121 are the same as the symbols that are set to lead to a jackpot and when the winning line selected by the player includes three or more the same symbols, the jackpot is played.

When the condition for the jackpot is not satisfied at step S230, a winning score is displayed by calculating the score bet by the player, and the winning score is allotted (S240).

Herein, the winning scores for individual reel games 120 are respectively displayed on the reel display windows 121.

When the condition for the jackpot is satisfied at step S230, either a jackpot score is displayed and allotted or a jackpot game is played, according to the set condition is determined (S231).

If the system is set to allot the jackpot score at step S231, the jackpot score is displayed and allotted at step S234.

Herein, the jackpot score is displayed in the individual reel display windows 121 or in the central display part to enable the player participating in the games to check whether the jackpot is won.

Also, when the system is set to lead to the jackpot game at step S231, the controller 110 drives the jackpot game in the central display unit 170 or in the individual reel display windows 121, displays a winning score as the result of the game, and allots the winning score (S232 to S233).

As described above, the present invention is configured to provide at least two reel games in a single screen and to operate the reel games at the same time. Accordingly, a player enjoys multiple reel games simultaneously, thus improving space occupancy.

In addition, the present invention provides at least two reel display screens to enable player enjoyment of a game by interconnecting the screen, or to allow an individual game.

The present invention relates to a game device. A player can enjoy multiple reel game devices by displaying multiple reel game devices on a single screen and can enhance an interest and enjoyment of a game.

Although exemplary embodiments of the present invention have been described for illustrative purposes, those skilled in the art will appreciate that various modifications, additions and substitutions are possible, without departing from the scope and spirit of the invention as disclosed in the accompanying claims.

1. A multi-reel game device, comprising:
at least two reel display windows on a single screen, each reel display window including reels formed by reel characters displaying at least one symbol in three or more rows and three or more columns, whereby at least one winning line that includes reel characters, each of reel characters being included on each reel to be displayed in said at least two reel display windows, is set in the multi-reel game device;
at least two betting buttons displaying different betting amounts such that a player is capable of selecting a betting amount for each reel display window, the betting amount of the reel display window being determined by selecting one of the betting buttons, and the determined betting amount being canceled when the selected betting button is selected once again or another betting button is selected; and
a controller simultaneously spinning the reels of the reel display window for which the betting amount is selected by a user selecting one of the betting buttons, simultaneously stopping the reels of the reel display window after a predetermined time, and allotting a winning score according to a dividend rate when more than a predetermined number of identical symbols of the stopped reels of the reel display window are determined to be included in a predetermined winning line,
wherein the controller differently displays the reel characters in a way that a contrast or a color of the reel characters displayed in the reel display window with the betting amount selected and a contrast or a color of the reel characters displayed in the reel display window without the betting amount selected are differently displayed.

2. The multi-reel game device of claim 1, wherein the contrast of the reel characters displayed in the reel display window with the betting amount selected and the contrast of the reel characters displayed in the reel display window without the betting amount selected are differently displayed.

3. The multi-reel game device of claim 1, wherein the betting buttons, except for the selected betting button, are displayed as a non-selected buttons.

4. The multi-reel game device of claim 3, wherein the betting buttons are provided with a betting button displaying “0”.

5. The multi-reel game device of claim 4, wherein the betting button displaying “0” is displayed the same as the selected betting button when the betting button displaying “0” is selected.

6. The multi-reel game device of claim 1, further comprising a start button, and wherein the betting buttons of each reel display window are configured with at least two buttons displaying different betting amounts, and the betting amount of each reel display window is determined by an immediately preceding selected betting button before the start button is inputted.

7. The multi-reel game device of claim 1, further comprising a start button, and wherein the controller sequentially spins and stops the reels of the reel display window for which the betting amount is selected when the start button is inputted.

8. The multi-reel game device of claim 1, wherein, when the betting amount is not selected, the controller displays the corresponding reels in a stopped state until the reel display screen for which the betting amount is selected stops spinning.

9. The multi-reel game device of claim 1, wherein the controller simultaneously spins and stops both of the reel display window for which the betting amount is selected, and the reel display window for which the betting amount is selected.

10. The multi-reel game device of claim 1, wherein the controller performs any one of allotting a bonus score, allotting a jackpot score, or playing a bonus game or a jackpot game when the stopped reel symbols displayed in the reel display window are the same as symbols that are set to play a predetermined bonus game.

11. The multi-reel game device of claim 1, wherein the color of the reel characters displayed in the reel display window with the betting amount selected and the color of the reel characters displayed in the reel display window without the betting amount selected are differently displayed.

12. The multi-reel game device of claim 1, wherein a betting button set for each reel display window comprises said at least two betting buttons.

13. The multi-reel game device of claim 1, wherein the betting button set for each reel display windows including a deactivation button

14. The multi-reel game device of claim 13, wherein the controller makes the reel display window for which the deactivation button is selected be handled not to be bet.

15. A multi-reel game device, comprising:
at least two reel display windows on a single screen, each reel display window including reels formed by reel characters displaying at least one symbol in three or more rows and three or more columns, whereby at least one winning line that includes reel characters, each of reel characters being included on each reel to be displayed in said at least two reel display windows, is set in the multi-reel game device;
a betting button set for each reel display window, the betting button set comprising at least two betting buttons displaying different betting amounts such that a player is capable of selecting a betting amount for each reel display window, the betting amount of the reel display window being determined by selecting one of the betting buttons, and the determined betting amount being canceled when the selected betting button is selected once again or another betting button is selected, the betting button set for each reel display windows including a deactivation button; and
a controller simultaneously spinning the reels of the reel display window for which the betting amount is selected by a user selecting one of the betting buttons, simultaneously stopping the reels of the reel display window after a predetermined time, and allotting a winning score according to a dividend rate when more than a predetermined number of identical symbols of the stopped reels of the reel display window are determined to be included in a predetermined winning line,
wherein the controller makes the reel display window for which the deactivation button is selected be handled not to be bet; and,
a contrast or a color of the reel characters of the reel display window with the betting amount selected and a contrast or a color of the reel characters of the reel display window for which the deactivation button is selected are differently displayed.
